(19) United States
(12) Patent Application Publication
(10) Pub. No.: US 2005/0207085 A1
(43) Pub. Date: Sep. 22, 2005

(54) Side vented arc path on network protector rollout

(76) Inventors: Arthur J. Jur, Greenwood, SC (US); Douglas M. Brandt, Greenwood, SC (US); John Robert Moffat, Greenwood, SC (US); Mark A. Faulkner, Greenwood, SC (US)

Correspondence Address: Martin J. Moran, Esquire;Eaton Electrical, Inc., Technology & Quality Center, 170 Industry Drive, RIDC Park West, Pittsburgh, PA, 15275-1032, US

(21) Appl. No.: 10/802,617

(22) Filed: Mar. 17, 2004

(51) Int. Cl. H02H 1/00

(52) U.S. Cl. 361/129

(57) ABSTRACT

A network protector that includes an enclosure, a frame assembly, a plurality of electrical components, including a circuit breaker, and an arc path assembly. The frame assembly is disposed within said enclosure. The plurality of electrical components is coupled to the frame assembly. The circuit breaker has at least one set of main contacts and at least one are chute associated with set of main contacts. The arc path assembly has a hollow member having at least one open end. The hollow member in fluid communication with the arc chute and the hollow member open end extends beyond said frame assembly. Thus, arc gasses traveling from the arc chute through the hollow member are exhausted into said enclosure.

### BACKGROUND OF THE INVENTION

1. Field of the Invention

The present invention relates to a network protector and, more specifically, to a network protector having an arc path structured to direct arc gasses away from the network protector electrical components.

2. Background Information

Secondary power distribution networks consist of interlaced grids which are supplied by two or more sources of power so that the loss of a single source of power will not result in an interruption of service. Such networks provide the highest level of reliability possible with conventional power distribution and are normally used to supply high-density load areas such as a section of a city, a large building, or an industrial site. Between the power sources and the network is a transformer and a network protector. Such network protectors are often found in dust-proof or moisture-proof housings which are disposed in subterranean passageways in large metropolitan areas. The housing, or “tank,” may be further disposed within a concrete vault.

The network protector consists of a circuit breaker and additional electrical components such as a control relay. The control relay senses the transformer and network voltages and line currents and executes algorithms to initiate breaker tripping or closing action. The circuit breaker and other components are typically mounted on a frame assembly. The frame assembly fits within the housing and is structured to allow the circuit breaker and other components to roll out of the housing. Because space within the enclosure is limited, the other electrical components are typically disposed immediately adjacent to, or coupled to the circuit breaker. However, other electrical components also need to be spaced from the exhaust path of the arc gasses described below.

The network protector is, typically, coupled to the line and the load by a three-phase bus. Thus, the network protector circuit breaker typically has three sets of separable contacts. The network protector circuit breaker includes an arc chute for each set of separable contacts. The arc chute is a non-conductive passage structured to extinguish the arc created when the contacts separate and to direct harmful gasses away from the contacts. The gasses must be vented as particulate matter, e.g. hot metal particles that have been vaporized by the arc and which condense as molten metal, associated with the gasses are deposited on adjacent surfaces. If the gasses were not vented, the deposits would eventually create an electrical path that would allow the arc to travel to the frame assembly, the other components or other parts of the circuit breaker. Such a situation is very undesirable.

Network protector circuit breakers have been improved to have higher interruption ratings. These improved circuit breakers require additional space for the arcing gasses to dissipate. However, given the limited space within the enclosure, there is no place for the gasses to be vented by the arc chutes that would not effect the circuit breaker or other electrical components.

There is, therefore, a need for an arc path assembly that is structured to direct the arc gasses and other particles away from the circuit breaker and other electrical components.

There is a further need for an arc path assembly that is structured to extend beyond the network protector frame assembly to reduce the chance of arc gas deposits creating a current path between the contacts and the circuit breaker or other electrical components.

There is a further need for an arc path assembly that is structured to allow the other electrical components of a network assembly to be mounted immediately adjacent to the circuit breaker.

### SUMMARY OF THE INVENTION

These needs, and others, are met by the present invention which provides an arc path assembly having a hollow member with at least one open end that is in fluid communication with each arc chute and which extends from the circuit breaker to a point beyond the network protector frame assembly. The hollow member directs arc gasses out of the arc chutes and away from the other electrical components. As such, the other electrical components may be mounted immediately adjacent to the circuit breaker.

The hollow member is, preferably, made from a non-conductive material. As such, any residual energy that is not extinguished in the arc chute will dissipate in the arc path assembly. Additionally, the hollow member is, preferably, an elongated member having a longitudinal axis that is generally perpendicular to the axis of each arc chute. As such, the flow path through which the arc gasses travel turns about ninety degrees. This turn in the flow path allows the arc gas particulate matter to collect on the non-conductive hollow member, thereby reducing the chance that deposits of arc gas particulate matter will create a flow path for electricity between the arc chute and other areas of the network protector.

### BRIEF DESCRIPTION OF THE DRAWINGS

A full understanding of the invention can be gained from the following description of the preferred embodiments when read in conjunction with the accompanying drawings in which:

FIG. 1 is a front view of a network protector.

FIG. 2 is a partial isometric view of a network protector without the enclosure and portions of the frame assembly.

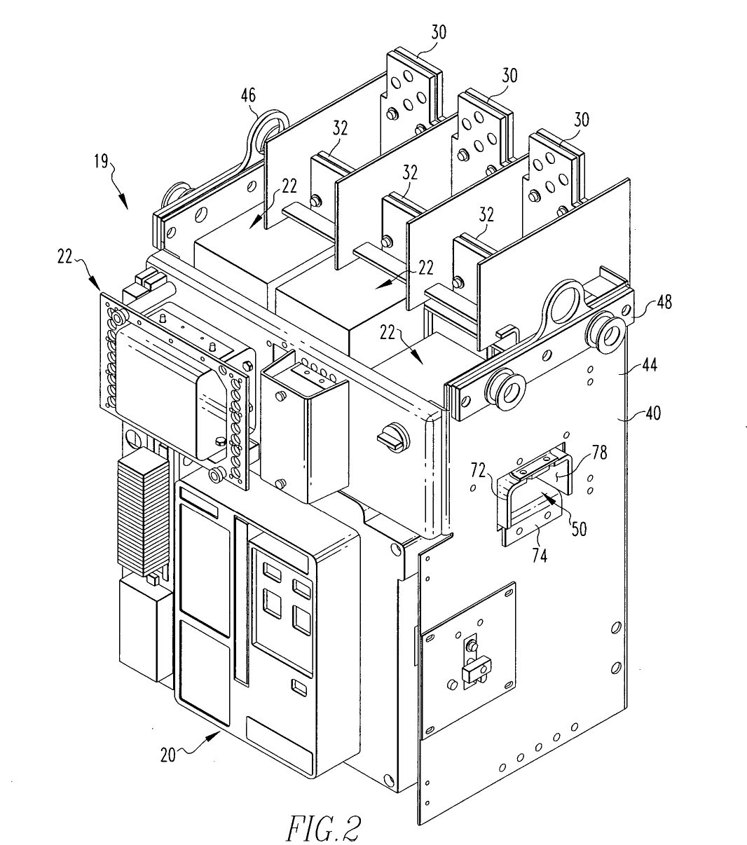

FIG. 3 is a schematic view of the flow path for arc gasses.

### DESCRIPTION OF THE PREFERRED EMBODIMENTS

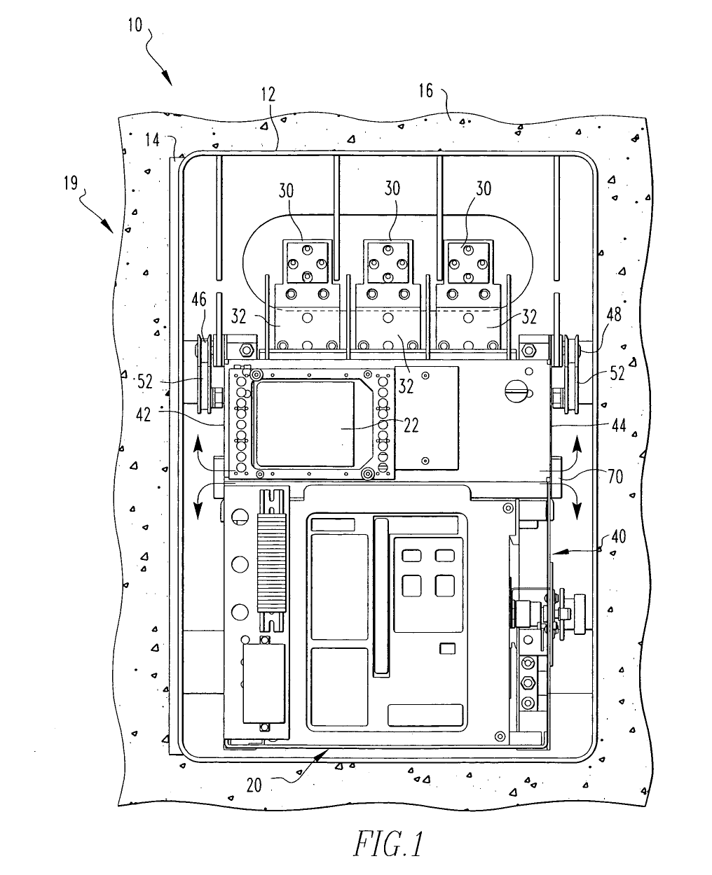

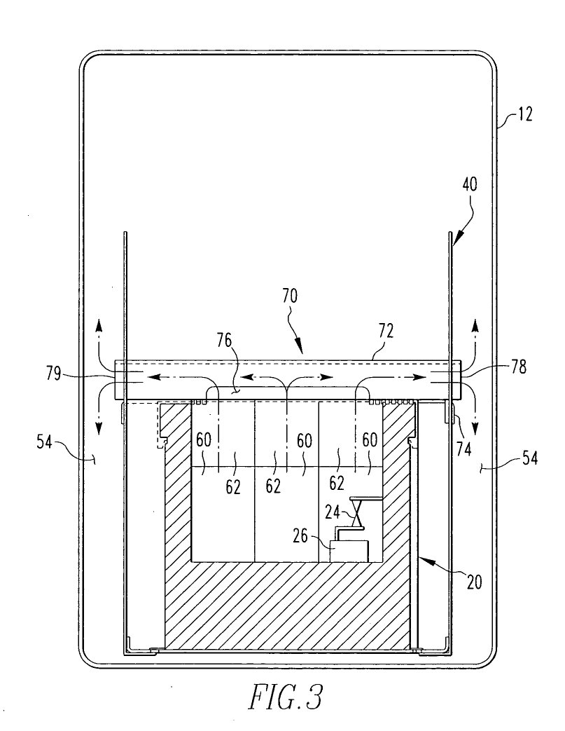

As shown in FIG. 1, a network protector 10 includes a tank 12 which includes a movable door 14. The tank 12 may be placed within a vault 16. The vault 16 is typically made of concrete or a similar material. The network protector 10 includes a plurality of electrical components 19 such as a circuit breaker 20 as well as other electrical components 22. The plurality of electrical components 19 are coupled, either directly or indirectly, to a frame assembly 40. The frame assembly 40 is structured to move in and out of the tank 12 as described below. The circuit breaker 20 includes at least one set of main contacts 24 (shown schematically, FIG. 3) that are structured to move between a first, open position and a second closed position. When the main contacts 24 are in the second, closed position, electricity may flow through the circuit breaker 20. When the main contacts 24 are in the first, open position, electricity cannot flow through the circuit breaker 20. The circuit breaker 20 also includes an operating mechanism 26 (shown schematically, FIG. 3) that is structured to move the main contacts 24 between the first and second position. The main contacts 24 are coupled to one or more network protector load buses 30 and one or more network protector line buses 32. In a preferred embodiment, shown in FIG. 1, the circuit breaker 20 is a three phase circuit breaker having three poles. Each pole includes a load bus 30 and a line bus 32.

The frame assembly 40 includes first and second side panels 42, 44, and first and second wheel assemblies 46, 48. One wheel assembly 46, 48 is coupled to each side panel 42, 44. The side panels 42, 44 are held in a spaced relation and the plurality of electrical components 19 are coupled to the side panels 42, 44. Each side panel 42, 44 includes an opening 50. The wheel assemblies 46, 48 are structured to engage rails 52 which are coupled to the tank 12. The frame assembly 40 may move into and out of the enclosure 12 to provide access to the plurality of electrical components 19. There is a gap 54 between the tank 12 and the side panels 42, 44.

As shown in FIG. 3, the circuit breaker 20 includes an arc chamber 60 and an arc chute 62 for each set of main contacts 24. Each arc chute 62 is in fluid communication with an associated arc chamber 60. In the preferred embodiment, the arc chute 62 is disposed above the associated arc chamber 60. When the main contacts 24 separate, the arc gasses are exhausted from the arc chamber 60 into the associated arc chute 62.

An arc path assembly 70 is disposed above the arc chutes 62. The arc path assembly 70 includes a hollow member 72 and at least one mounting bracket 74. The hollow member 72 is preferably an elongated, rectangular tube. The hollow member 72 has a side opening 76 and at least one end opening 78. In a preferred embodiment, each end of the hollow member 72 includes an opening 78, 79. The hollow member 72 is coupled to the circuit breaker 20 with the side opening 76 in fluid communication with each arc chute 62. The hollow member 72 is, preferably, generally perpendicular to the direction of travel of the arc gas within the arc chutes 62. That is, because the arc gas travels generally vertically, the hollow member 72 extends generally horizontally. The hollow member 72 has a length sufficient so that, when the network protector 10 is assembled, the at least one end opening 78, or both end openings 78, 79, extend beyond the frame assembly 40. That is, the end openings 78, 79 extend into the gap 54 between the tank 12 and the side panels 42, 44. The hollow member 72 is, preferably, made from a non-conductive material such as, but not limited to, fiber reinforced plastic resin, plastic resin coated fabric, vulcanized fabric, and fiber reinforced polyester laminate.

Accordingly, in operation, when each pair of main contacts 24 separates, an arc and arc gasses are formed. The arc path and path of travel for the arc gasses is shown by the arrows. The arc is generally extinguished in the arc chute 62, however, any energy not extinguished in the arc chute 62 will be dissipated in the hollow member 72. Arc gasses travel from the arc chambers 60 through the arc chutes 62 and into the hollow member 72 via the side opening 76. Because the hollow member 72 extends generally horizontally and the arc chutes 62 extend generally vertically, the arc gasses are turned about ninety degrees as the gasses move from the arc chutes 62 into the hollow member 72. The momentum of particulate matter in the arc gasses will cause the particulate matter to impinge and adhere to the hollow member 72. The remainder of the arc gasses travels through the hollow member 72 and exits the arc path assembly 70 in the gap 54 between the tank 12 and the side panels 42, 44.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

1. A network protector comprising:
an enclosure;
a frame assembly disposed within said enclosure;
a plurality of electrical components including a circuit breaker coupled to said frame assembly and having at least one set of main contacts and at least one arc chute associated with set of main contacts;
an arc path assembly having a hollow member having at least one open end, said hollow member in fluid communication with said arc chute; and
said hollow member extending beyond said frame assembly, whereby arc gasses traveling from said arc chute through said hollow member are exhausted into said enclosure.

2. The network protector of claim 1, wherein:
said at least one arc chute extends generally vertically; and
said hollow member extends generally horizontally.

3. The network protector of claim 2, wherein
said circuit breaker includes three sets of main contacts and said at least one arc chute includes three arc chutes, one arc chute being associated with each set of main contacts; and
said hollow member being coupled to said circuit breaker and wherein said hollow member is in fluid communication with each arc chute.

4. The network protector of claim 3, wherein said hollow member is made from a non-conductive material.

5. The network protector of claim 4, wherein said hollow member is made from fiber reinforced plastic resin, plastic resin coated fabric, vulcanized fabric, and fiber reinforced polyester laminate.

6. The network protector of claim 5, wherein said hollow member includes two open ends, each open end extending beyond said frame assembly.

7. The network protector of claim 6, wherein each said open end is disposed within said enclosure.

8. The network protector of claim 1, wherein said hollow member includes two open ends, each open end extending beyond said frame assembly.

9. The network protector of claim 8, wherein each said open end is disposed within said enclosure.

10. The network protector of claim 1, wherein said hollow member is made from a non-conductive material.

11. An arc path assembly for a network protector, said network protector having a plurality of electrical components including a circuit breaker disposed on a frame assembly within an enclosure, said circuit breaker having at least one set of main contacts and at least one generally vertical arc chute associated with said at least one set of main contacts, said arc path assembly comprising:
a hollow member having at least one open end and at least one side opening;
said side opening structured to be coupled to said at least one arch chute; and
said at least one open end extending beyond said frame assembly, whereby arc gasses traveling from said arc chutes pass through said hollow member and are exhausted into said enclosure.

12. The arc path assembly of claim 11, wherein:
said at least one arc chute extends generally vertically; and
said hollow member extends generally horizontally.

13. The arc path assembly of claim 12, wherein
said circuit breaker includes three sets of main contacts and said at least one arc chute includes three arc chutes, one arc chute being associated with each set of main contacts; and
said hollow member being coupled to said circuit breaker and wherein said hollow member is in fluid communication with each arc chute.

14. The arc path assembly of claim 13, wherein said hollow member is made from a non-conductive material.

15. The arc path assembly of claim 14, wherein said hollow member is made from fiber reinforced plastic resin, plastic resin coated fabric, vulcanized fabric, and fiber reinforced polyester laminate.

16. The arc path assembly of claim 15, wherein said hollow member includes two open ends, each open end extending beyond said frame assembly.

17. The arc path assembly of claim 16, wherein each said open end is disposed within said enclosure.

18. The arc path assembly of claim 11, wherein said hollow member includes two open ends, each open end extending beyond said frame assembly.

19. The arc path assembly of claim 18, wherein each said open end is disposed within said enclosure.

20. The arc path assembly of claim 11, wherein said hollow member is made from a non-conductive material.
